(19) United States
(12) Patent Application Publication
(10) Pub. No.: US 2005/0261903 A1
(43) Pub. Date: Nov. 24, 2005

(54) Voice recognition device, voice recognition method, and computer product

(75) Inventors: Yoshihiro Kawazoe, Saitama (JP); Kenichiro Yano, Tokyo (JP)

Correspondence Address: FOLEY AND LARDNER;SUITE 500, 3000 K STREET NW, WASHINGTON, DC, 20007, US

(73) Assignee: PIONEER CORPORATION

(21) Appl. No.: 11/131,218

(22) Filed: May 18, 2005

(30) Foreign Application Priority Data
May 21, 2004 (JP) 2004-152434

(51) Int. Cl. G10L 15/00

(52) U.S. Cl. 704/247

(57) ABSTRACT

When a voice of the user cannot be recognized, a voice recognition device automatically switches to a voice command registration mode. In the voice command registration mode, the user is caused to select a desired processing, the unrecognized voice is registered, and the desired processing is executed.

### BACKGROUND OF THE INVENTION

1) Field of the Invention

The present invention relates to a voice recognition device, a voice recognition method, and a computer product.

2) Description of the Related Art

There are various devices that recognize a voice command and execute a processing according to the voice command. This technology is typically applied where the user's hands are busy. For example, this technology is applied to in-car devices including car navigation systems and car audio systems; because it is hazardous for a driver to look away from the road to manually operate the device.

These devices typically store predetermined voice commands such as “present location” to display a present location of a car, and also allow users to register arbitrary voice commands corresponding to arbitrary processings. For example, in addition to “present location”, the user can register a command such as “where am I?” to display the present location.

Japanese Patent Application Laid Open No. 2000-276187 discloses a device that has a function to register such unknown words. When a voice is input to a voice input section, a voice recognition section analyzes the voice frequency of the voice to generate a pattern characterizing the words, and verifies the pattern with word patterns registered in a recognition dictionary. When the same or similar word pattern exists in the recognition dictionary, corresponding operation data is output to an operation section, and the operation section is activated. When an operation performed by the operation section is not what the user intended, or when the voice recognition section determines that the voice recognition is unsuccessful, the user is requested to select the operation manually. When the user selects the operation manually via the operation section, the voice recognition section reads operation data corresponding to the operation selected. The word pattern generated is then registered to the recognition dictionary, as another word pattern corresponding to the intended operation.

However, the operations required to register an unknown word are complicated and troublesome. For example, the user is required to repeat the same word, and the device needs to be switched from an “operation mode” to a “register mode.” Therefore, users, particularly beginners, tend to be reluctant to use the function to register unknown words. It is inconvenient to use the device unless words familiar to the user are registered for frequently used functions.

### SUMMARY OF THE INVENTION

It is an object of the present invention to at least solve the problems in the conventional technology.

According to an aspect of the present invention, a voice recognition device includes a voice recognition unit that performs voice recognition with respect to a voice of a user; an errata determination unit that determines whether the voice recognition is successful; a processing selection unit that causes the user to select a processing corresponding to the voice when the errata determination unit determines that the voice recognition is unsuccessful; a voice registration unit that registers the voice as a voice command to execute the processing selected; and an execution command unit that commands execution of the processing.

According to another aspect of the present invention, a voice recognition method includes performing voice recognition with respect to a voice of a user; determining whether the voice recognition is successful; causing the user to select a processing corresponding to the voice for which the voice recognition is unsuccessful; registering the voice as a voice command to execute the processing selected; and commanding execution of the processing.

According to still another aspect of the present invention, a computer-readable recording medium stores therein a computer program that implements the above method on a computer.

The other objects, features, and advantages of the present invention are specifically set forth in or will become apparent from the following detailed description of the invention when read in conjunction with the accompanying drawings.

### BRIEF DESCRIPTION OF THE DRAWINGS

FIG. 1 is an example of a hardware configuration of a voice recognition device according to an embodiment of the present invention;

FIG. 2 is a functional configuration of the voice recognition device;

FIG. 3 schematically describes a table including predetermined processings and corresponding voice commands;

FIG. 4 is a flowchart of an operation performed by the voice recognition device;

FIG. 5 is an example of a display to select a processing when voice recognition is unsuccessful; and

FIG. 6 schematically describes the table shown FIG. 3 after an unknown word is registered.

### DETAILED DESCRIPTION

Exemplary embodiments of the present invention will be described below with reference to accompanying drawings.

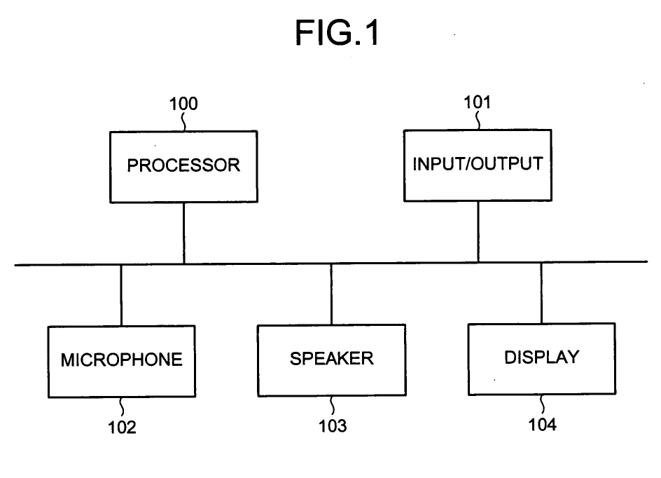

FIG. 1 is an example of a hardware configuration of a voice recognition device according to an embodiment of the present invention. It is assumed here that the voice recognition device is used in a car navigation system, and executes a processing according to a voice command. The voice recognition device includes a processor 100, a memory 101, a microphone 102, a speaker 103, and a display 104.

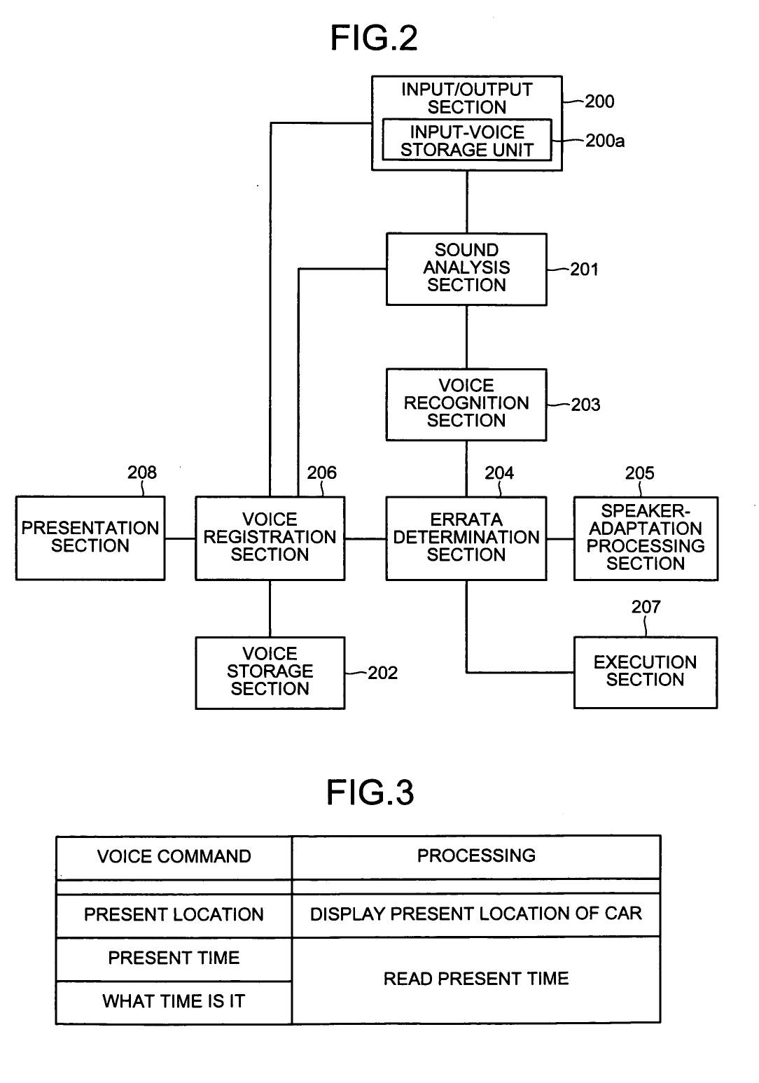

FIG. 2 is a functional configuration of the voice recognition device. The voice recognition device includes an input/output section 200, a sound analysis section 201, a voice storage section 202, a voice recognition section 203, an errata determination section 204, a speaker-adaptation processing section 205, a voice registration section 206, an execution section 207, and a presentation section 208.

The input/output section 200 receives input of a voice of a user, and outputs a notification or a question to the user by using a sound or a display. The input/output section 200 is realized by the microphone 102, the speaker 103, the display 104, and the processor 100 that controls these components. The input/output section 200 also includes an input-voice storage unit 200a that temporarily stores the voice. The input-voice storage unit 200a is realized by the memory 101.

The sound analysis section 201 calculates various sound parameters characterizing the voice input from the input/output section 200. The sound analysis section 201 is realized by the processor 100.

The voice storage section 202 stores a table including predetermined processings and voice commands (templates) used to execute a corresponding processing. The voice storage section 202 is realized by the memory 101. FIG. 3 schematically describes the table. At least one voice command is assigned to each processing in the table.

The voice recognition section 203 specifies (recognizes) a voice command stored in the table that matches an input voice, based on results of the sound analysis section 201 (hereinafter, “voice recognition). The voice recognition section 203 is realized by the processor 100. There are various methods used for voice recognition, such as dynamic programming (DP), neutral networking, and so on. The embodiment employs the Hidden Markov Model (HMM), which is a typically used method. The voice recognition section 203 compares the sound parameters of the voice with those of the predetermined templates (each voice command in the table of FIG. 3), and calculates a likelihood (score) for each template. The template with the highest likelihood is notified to the errata determination section 204.

The errata determination section 204 determines whether the voice recognition is successful, and when the voice recognition is successful, outputs a command to the execution section 207 to execute a processing intended by the user. The errata determination section 204 is realized by the processor 100. When the likelihood is equal to or more than a predetermined threshold, the errata determination section 204 determines that the voice recognition is successful. The errata determination section 204 then outputs the voice to the speaker-adaptation processing section 205, and a command to execute the corresponding processing to the execution section 207, respectively. On the other hand, when the likelihood is less than the predetermined threshold, the errata determination section 204 determines that the voice recognition is unsuccessful. When the voice recognition is unsuccessful, the errata determination section 204 instructs the voice registration section 206 to register the voice as a voice command in the table shown in FIG. 3, and outputs to the execution section 207 a command to execute the corresponding processing.

The speaker-adaptation processing section 205 performs a speaker adaptation processing when the errata determination section 204 determines that the voice recognition is successful. The speaker adaptation processing adapts the corresponding template to the user's voice, so as to improve a recognition rate for the user's voice. The speaker-adaptation processing section 205 is realized by the processor 100. Conventional methods such as the maximum likelihood linear regression (MLLR) or the maximum a posteriori probability (MAP) estimation method can be used for the speaker adaptation processing.

The voice registration section 206 registers the voice for one of the processings in the table shown in FIG. 3, when the errata determination section 204 determines that the voice recognition is unsuccessful. The voice registration section 206 is realized by the processor 100. The execution section 207 actually executes the processing according to the command of the execution section 207. The execution section 207 is realized by the processor 100 and various hardware components (not shown).

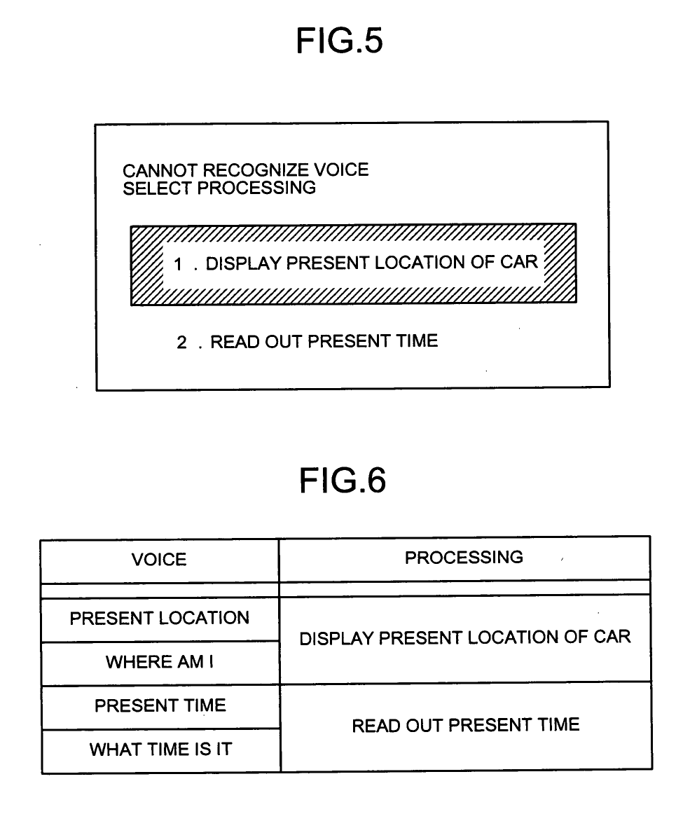

The presentation section 208 presents contents that are already registered in the voice registration section 206. Specifically, when the user selects the processing on the display shown in FIG. 5, the corresponding voice command already registered is presented to the user with a voice or a display. The presentation section 208 is realized by the processor 100.

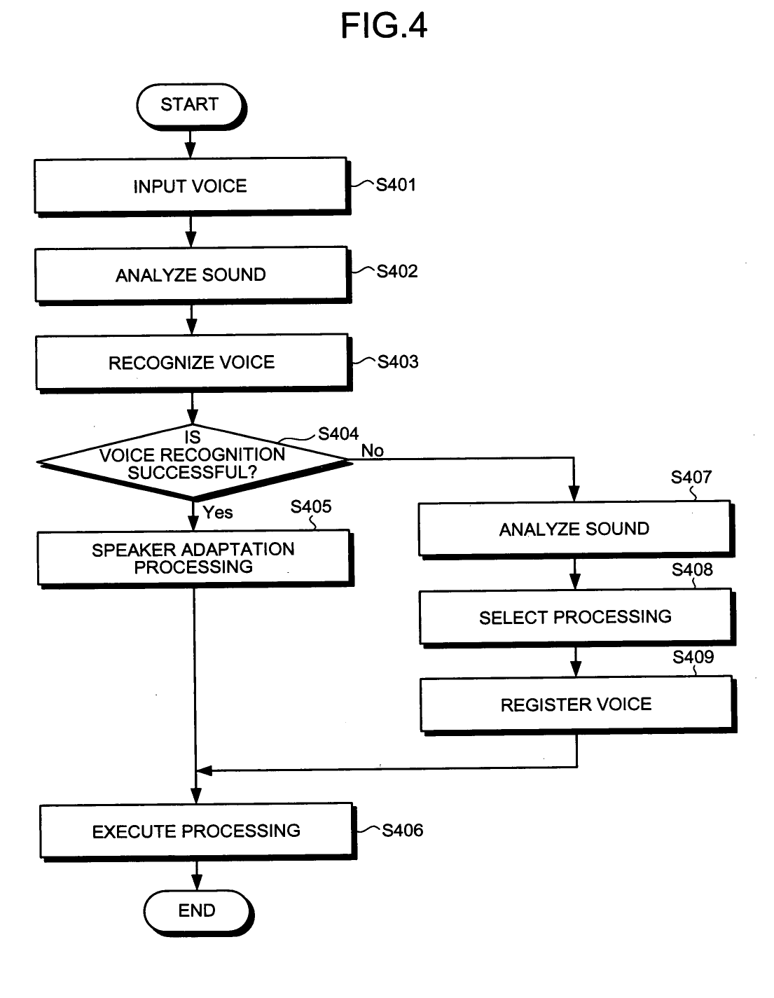

FIG. 4 is a flowchart of an operation performed by the voice recognition device. The input/output section 200 receives a voice of a user (step S401), the sound analysis section 201 analyzes the sound of the voice (step S402), and the voice recognition section 203 performs voice recognition (step S403).

When the errata determination section 204 determines that the voice recognition is successful (“Yes” at step S404), the errata determination section 204 outputs the voice to the speaker-adaptation processing section 205, and the speaker-adaptation processing section 205 performs speaker adaptation processing (step S405). The errata determination section 204 also outputs a command to execute a processing corresponding to the voice to the execution section 207, and the execution section 207 executes the processing (step S406).

When the voice recognition is unsuccessful (“No” at step S404), the errata determination section 204 instructs the voice registration section 206 to register the voice in the table shown in FIG. 3. Specifically, the voice registration section 206 instructs the sound analysis section 201 to perform sound analysis of the voice stored in the input-voice storage unit 200a so as to register the voice as a template in the table shown in FIG. 3 (step S407). The sound analysis section 201 can include an analysis result storage section that stores the analysis result of step S402, so that the same result is reused to omit step S407.

The voice registration section 206 instructs, when the voice recognition is unsuccessful, the input/output section 200 to output a predetermined alarm sound to the speaker 103 to inform the speaker 103 that something is wrong, and to output a display as shown in FIG. 5 on the display 104. The user selects a processing on the display 104 (step S408). The selected processing is informed to the input/output section 200, and a template of the voice is registered for the corresponding processing in the table shown in FIG. 3 (step S409). The voice registration section 206 notifies the corresponding processing to the errata determination section 204, the errata determination section 204 outputs a command to execute the processing to the execution section 207, and the execution section 207 actually executes the processing (step S406).

For example, when a present location of a car is to be displayed on the display 104 of the car navigation system, a user can execute the processing by saying “present location” (steps S401 to S406). This corresponds to the flow on the left side of the flowchart in FIG. 4, which is the same as the conventional technology. However, if the user says “where am I?” which is not registered in the table shown in FIG. 3, the likelihood for each template will be less than the threshold, i.e., “No” at step S404. In this case, steps S407 to S409 are executed. “Where am I?” which is an unknown word or phrase (i.e., the one that is not registered in the table shown in FIG. 3), is then registered to the table shown in FIG. 3 as a template corresponding to the processing to display the present location of the car. FIG. 6 schematically describes the table shown FIG. 3 after the unknown word is registered.

The initial voice command to execute the processing to display the present location of the car is “present location”; therefore, “where am I?” cannot be recognized at first. However, “where am I?” can also be registered simply by saying it once, and then selecting the desired processing on the display shown in FIG. 5. Therefore, complicated and troublesome operations are not necessary, such as repeating the same word and switching the mode of the device. The user can easily register unknown words or phrases in the course of a regular operation. Even a beginner can register a familiar word for a frequently used processing, so that the voice recognition device is customized to suit the convenience of each user.

In a conventional speaker-adaptation processing, when a voice is not recognized successfully, the voice was simply discarded (if a corresponding template is not registered). However, in the embodiment according to the present invention, the unrecognized voice can be effectively utilized, to facilitate registration of unknown words or phrases.

Further, even when the voice recognition is unsuccessful, the voice can be registered for a desired processing. However, when the user does not desire to register the voice, the system control can output a question to the user, such as “register voice command?” after step S408. The voice is registered at step S409 only when desired by the user.

In the embodiment, the user selects a processing corresponding to the voice, from among predetermined processings stored in the table shown in FIG. 3. The user can also register the voice for a processing executed by a method other than a voice command (such as button operation), immediately after it is determined that the voice recognition is unsuccessful. Accordingly, unknown voice commands can be registered for processings other than those stored in the table shown in FIG. 3.

A plurality of voice commands can be registered for each processing. However, the number of voice commands to be registered for each processing can be restricted to, for example, five voice commands.

The user might register an unknown voice command, such as “present position”, without knowing that a similar voice command, such as “present location”, is already registered. As the user can confirm the voice command already registered at the presentation section 208, such redundancy is prevented.

In the embodiment, it is automatically determined as to whether the voice recognition is successful by comparing likelihood and a threshold of a template. Thus, an incorrect voice command might be selected, and an unintended processing might be executed. To prevent this problem, the user can be asked each time whether the voice command corresponds to an intended processing, regardless of the likelihood.

According to the present invention, when it is determined that the voice recognition is unsuccessful, the voice recognition device automatically switches to a voice command registration mode (without requiring a specific operation), and then the processing corresponding to the voice is executed. According to the present invention, when it is determined that the voice recognition is successful; the processing corresponding to the voice is automatically executed. According to the present invention, the speaker adaptation processing is also executed when it is determined that the voice recognition is successful. According to the present invention, the user can confirm the voice command that is already registered, before registering a voice command.

A voice recognition method according to the embodiment of the present invention can be implemented on a computer program by executing a computer program. The computer program can be stored in a computer-readable recording medium such as ROM, HD, FD, CD-ROM, CD-R, CD-RW, MO, DVD, and so forth, or can be downloaded via a network such as the Internet. The connection between the voice recognition device and the network can be wired or wireless.

Although the invention has been described with respect to a specific embodiment for a complete and clear disclosure, the appended claims are not to be thus limited but are to be construed as embodying all modifications and alternative constructions that may occur to one skilled in the art that fairly fall within the basic teaching herein set forth.

The present document incorporates by reference the entire contents of Japanese priority document, 2004-152434 filed in Japan on May 21, 2004.

1. A voice recognition device comprising:
a voice recognition unit that performs voice recognition with respect to a voice of a user;
an errata determination unit that determines whether the voice recognition is successful;
a processing selection unit that causes the user to select a processing corresponding to the voice when the errata determination unit determines that the voice recognition is unsuccessful;
a voice registration unit that registers the voice as a voice command to execute the processing selected; and
an execution command unit that commands execution of the processing.

2. The voice recognition device according to claim 1, wherein the execution command unit commands execution of a processing that corresponds to the voice for which the voice recognition is successful.

3. The voice recognition device according to claim 2, further comprising a speaker adaptation unit that performs a processing to improve a recognition rate of the voice for which the voice recognition is successful.

4. The voice recognition device according to claim 2, further comprising:
a storage unit that stores a table including predetermined processings and corresponding voices; and
a speaker adaptation unit that performs a processing, when the voice recognition is successful, to adapt a predetermined processing in the table corresponding to the voice so as to improve a recognition rate of the user's voice.

5. The voice recognition device according to claim 1, further comprising a presentation unit that presents to the user, before the voice registration unit registers the voice, contents that are already registered.

6. A voice recognition method comprising:
performing voice recognition with respect to a voice of a user;
determining whether the voice recognition is successful;
causing the user to select a processing corresponding to the voice for which the voice recognition is unsuccessful;
registering the voice as a voice command to execute the processing selected; and
commanding execution of the processing.

7. The voice recognition method according to claim 6, wherein a processing that corresponds to the voice is commanded at the commanding when the voice recognition is successful.

8. The voice recognition method according to claim 7, further comprising performing a processing to improve a recognition rate of the voice for which the voice recognition is successful.

9. The voice recognition method according to claim 7, further comprising:
storing a table including predetermined processings and corresponding voices; and
performing a processing, when the voice recognition is successful, to adapt a predetermined processing in the table corresponding to the voice so as to improve a recognition rate of the user's voice.

10. The voice recognition method according to claim 6, further comprising presenting to the user, before the voice is registered at the registering, contents that are already registered.

11. A computer-readable recording medium that stores therein a computer program that causes a computer to execute:
performing voice recognition with respect to a voice of a user;
determining whether the voice recognition is successful;
causing the user to select a processing corresponding to the voice for which the voice recognition is unsuccessful;
registering the voice as a voice command to execute the processing selected; and
commanding execution of the processing.

12. The computer-readable recording medium according to claim 11, wherein a processing that corresponds to the voice is commanded at the commanding when the voice recognition is successful.

13. The computer-readable recording medium according to claim 12, wherein the computer program further causes the computer to execute performing a processing to improve a recognition rate of the voice for which the voice recognition is successful.

14. The computer-readable recording medium according to claim 12, wherein the computer program further causes the computer to execute:
storing a table including predetermined processings and corresponding voices; and
performing a processing, when the voice recognition is successful, to adapt a predetermined processing in the table corresponding to the voice so as to improve a recognition rate of the user's voice.

15. The computer-readable recording medium according to claim 11, wherein the computer program further causes the computer to execute presenting to the user, before the voice is registered at the registering, contents that are already registered.
